(19) United States
(12) Patent Application Publication
(10) Pub. No.: US 2019/0135422 A1
(43) Pub. Date: May 9, 2019

(54) Method and Apparatuses for Building Flying Machine with Disc Shape Structure Using the normal Aerodynamics Principals

(71) Applicant: Qussay Abdulatteef Jasim Al-Aani, TAMPA, FL (US)

(72) Inventor: Qussay Abdulatteef Jasim Al-Aani, TAMPA, FL (US)

(21) Appl. No.: 15/919,660

(22) Filed: Mar. 13, 2018

Related U.S. Application Data
(60) Provisional application No. 62/601,692, filed on Mar. 27, 2017.

(51) Int. Cl. B64C 29/00; B64C 3/10; B64C 1/00; B64C 37/00; B64D 7/00; B64C 19/00; B64F 5/00

(52) U.S. Cl. CPC B64C 29/00; B64C 3/10; B64C 1/00; B64F 5/00; B64D 7/00; B64C 19/00; B64C 37/00

(57) ABSTRACT

The Flying Machine will be capable of flying and balancing with Automatic Balancing control system to keep itself flying while in motion or stationary using gyroscopes and computers, and propelled by motors and vector jets to be able to fly supersonic or subsonic depending on the designee needs, speed or carrying weights and able to fly or come to a complete stop without losing its balance using sensors so that the ground reaction force exactly balance all the other internal and external forces it experiences, such as gravitational if leaning, inertial or centrifugal

### BACKGROUND OF THE INVENTION

The present invention relates to a method and apparatus for building a flying machine that uses the principals and aerodynamic forces apply for normal horizontal airfoil flying airplane (VTOL-using thrust vectoring rotating at 180 deg to gain the wing lift vertically and horizontally) using disc shape structure (Flying Saucer—coincidental resemblance) using all airfoil and aerodynamic forces applies to normal airfoils.

### SUMMARY OF THE INVENTION

The present invention relates to a method and apparatus for using equal foil segments of triangular (delta) shape wings with wider at the trailing edge than the leading edge with finite thickness (span of the wing) and all its parameters found in NACA thick and thin foils. Adding these foil segments to each other (integrating) the segments surfaces together to form circular disc (flying Saucer) FIG. 1, FIG. 2 and FIG. 3

Its long root chord also allows a deeper structure for a given aerofoil section, providing more internal volume for fuel and other storage (if needed). Because of its light, robust structure with span at an elevated angle from the ground level at the leading edge (centre hole of the discs at the center-where airflow enter to the lower wing foil sides) and on the ground level at the trailing edge end at an angle range between (0-45) degree. There will be circular opening in the middle where the cockpit (or at the bottom of the disc to have lower centre of gravity for stability) and where the start of airflow entrance hitting the Delta airfoil leading edges very similar to the well known flying saucer(coincidental resemblance) but with all the Aerodynamics lift Principals applies for normal airplane and wings, converting aerodynamic forces to fly vertically and horizontally with very strong shell structure (well known scientific fact) and compactness with unlimited size in carrying capacity of passengers and cargo, with great maneuverability needed for the air force airplanes, which will depend on the number and strength of Thrust vectoring Engines used on the flying discs structures.

The cockpit can be placed on top of flying disc at the circular opening as described above or at the lower bottom part of the flying disc to see better on landing and to put all cargo and equipment and fuel tank at the lowest part of the flying disc underneath the cockpit to lower the centre of gravity to get much better stability to the flying discs

All the outside surfaces can be covered with solar panels to give the Electricity and power needed to the flying disc

In principal this flying disc shape can be converted to be used as submarine (many natural swimming sea creatures have similar shapes very successfully), using all the hydrodynamic principals to build the new shape submarine if all parts are made water leak proof and use hydrodynamic principals in its designs but using the same shape and suitable hydrodynamic thrust propeller machines.

Brief History of Aviation

The history of aviation has extended over more than two thousand years, from the earliest forms of aviation, kites and similar attempts, Fluid dynamics and Newton's laws of motion, led to the foundation of modem aerodynamics. The Wright brothers built and tested a series of kite and glider designs they flew successfully hundreds of times they helped advance the science of aeronautical engineering. In the latter part of the 20th century the advent of digital electronics produced great advances in flight to supersonic, and hypersonic flight by powered jets instrumentation and “fly-by-wire” systems

The 21st century saw the large-scale use of pilotless drones for military, civilian and leisure, digital technology allowed subsonic military aviation to begin eliminating the pilot in favor of remotely operated or completely autonomous (UAVs)

Brief History of Disc Shape Flying Machines (Flying Saucers);

Avro Canada develop disc shape aircraft and conducted experiments on the way airflow tends to stick to gently curved surfaces, a phenomenon called the Coda effect. And form a cushion of air on which the craft could hover FIG. 19. It was totally symmetrical, and had a central turbine, the exhaust exited from vents placed along the circumference of the aluminum saucer; vanes and shutters directed the exhaust toward the ground to hover. Once in the air, the disc shaped saucer's pilot would reroute the exhaust to one side of the craft to move, when the saucer rises above its 3-foot cushion of exhaust, it became unstable, oscillates on its rim when dropped on hard ground. Pilot aborts the flight and sets the Avro down

Engineers today can design very maneuverable aircraft and expect computers, gyroscopes to keep their creations airborne. Flight-control processors translate pilot instructions from the control stick to make countless adjustments of the engine nozzle and flight-control surfaces and the Avro could be seen as a prototype for the early generations of hovercraft, lacking only a ‘skirt’. There is at least one design that received a US patent in 2005: U.S. Pat. No. 6,960,975 It claims to be “propelled by the pressure of inflationary vacuum state”

The University of Florida has begun work on a Wingless Electromagnetic Air Vehicle (WEAV) for NASA which has received public interest because of its coincidental resemblance to a flying saucer, the plasma flying saucer; the concept the saucer will hover and propel itself using electrodes that cover its surface to ionize the surrounding air into plasma. Gases (such as air, which has an equal number of positive and negative charges) become plasma when energy (such as heat or electricity) causes some of the gas's atoms to lose their negatively charged electrons, creating atoms with a positive charge, or positive ions, surrounded by the newly detached electrons. Using an onboard source of energy (such as a battery, ultra capacitor, solar panel or any combination thereof), the electrodes will send an electrical current into the plasma, causing the plasma to push against the neutral (non-charged) air surrounding the craft, theoretically generating enough force for liftoff and movement in different directions (depending on where on the craft's surface you direct the electrical current).

### DESCRIPTION OF THE DRAWINGS

Elements in the figures have not necessarily been drawn to scale in order to enhance their clarity and improve understanding of these various elements and embodiments of the invention furthermore, elements that are known to be common and well understood to those in the industry may not be depicted in order to provide a clear view of the various embodiments of the invention; thus the drawings are generalized in form in the interest of clarity and conciseness;

FIG. 1 wing segments of flying disc & addition of wing segments to form flying disc using equal delta wing segments with best lift parameters, triangular (delta) shape wing with wider at the trailing edge than the leading edge with finite thickness (span of the wing) and all its parameters found in NACA by adding these segments to each other (integrating) the segments surfaces together to form circular disc (flying Saucer)

FIG. 2 the wing segments of flying disc described above in FIG. 1

FIG. 3 in horizontal flight the outside structure designed for subsonic flying disc using NACA thick wing designed for subsonic, low speed, high drag, high lift, low center of gravity for stability fitted with two Gyroscopes for stability

FIG. 4 schematic lift on airfoils

FIG. 5 disc-cone shape like flying disc (flying saucer) in horizontal flight the outside structure designed for supersonic flying disc using NACA thin wing designed for supersonic, high speed, low drag, low lift, low center of gravity for stability fitted with two Gyroscope for stability

FIG. 6 schematic wing lift and pressure on surfaces of outside body structure of flying disc in horizontal flight

FIG. 7 details cross section of the full schematic description of the body structure of the flying disc showing the possible position of the wings, cockpit, body, fuel tanks

FIG. 8 bi-flying disc, full schematic description of the body structure of the bi-flying disc

FIG. 9 Aircraft with Blown flaps, or jet flaps, with low pressure engine air throw wing slots can be very beneficial in the flying disc design can be used in the flying disc beneficially, when these flaps placed all around the upper surface of the flying discs beneficially and these blown flaps will power aerodynamic high-lift devices used on the wings

FIG. 10 Aircraft with Blown flaps, or jet flaps these blown flaps will power aerodynamic high-lift devices used on the wings

FIG. 11 Airlift produced by the wing shape using Bernoullie Principal

FIG. 12 Newtons third low applied to thrust and Rotatable Thrust Vectoring in Straight line and blowing on takeoff

FIG. 13 Bernoullie Principal apply to airflow on wings giving lift wings lift properties as shown in the parameters in NACA table

FIG. 14 properties of wing with flaps and slots and lift variation

FIG. 15 the Junkers design and slotted plain flap, Triple-slotted flap, pressure flaps where the flap are fixed below the trailing edge of the wing design allows airflow to pass between the wing and flap, even when the flap is retracted useful in flying disc design Flaps, aileron slotted, Junkers shown which can all be used on the flying discs

FIG. 16 flaps and slots can be very useful in the flying disc designs, Plain flaps with different position and slots can be very useful in the flying disc designs with Slotted flaps and slots can be very useful in the flying disc designs

FIG. 17 Slotted and plain flaps which can be used on the flying disc junkers flaps extended and retracted which can be used on the flying discs

FIG. 18 Blowing low pressure through wings can make large differences in lift, choice of flaps and slates and slots to be used on the flying disc wing to get the best lift when airstream flowing

FIG. 19 Flying saucer full design drawings done by Avro for NASA, Avro could be seen as a prototype for the early generations of hovercraft, lacking only a ‘skirt’

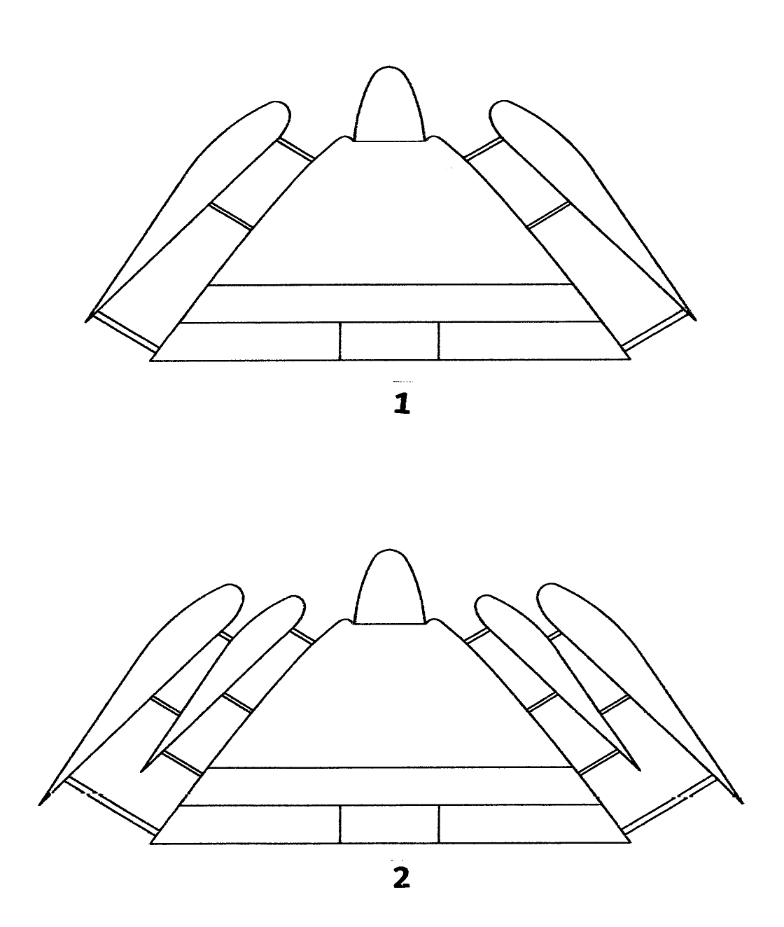

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced.

It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Embodiments of the present invention will now be described, by way of example, with reference to the accompanying drawings. While particular embodiments have been described, it will be understood that various modifications may be made without departing from the scope of the invention.

The Flying Machine with Disc Shape Structure (Flying Saucer—Coincidental Resemblance);

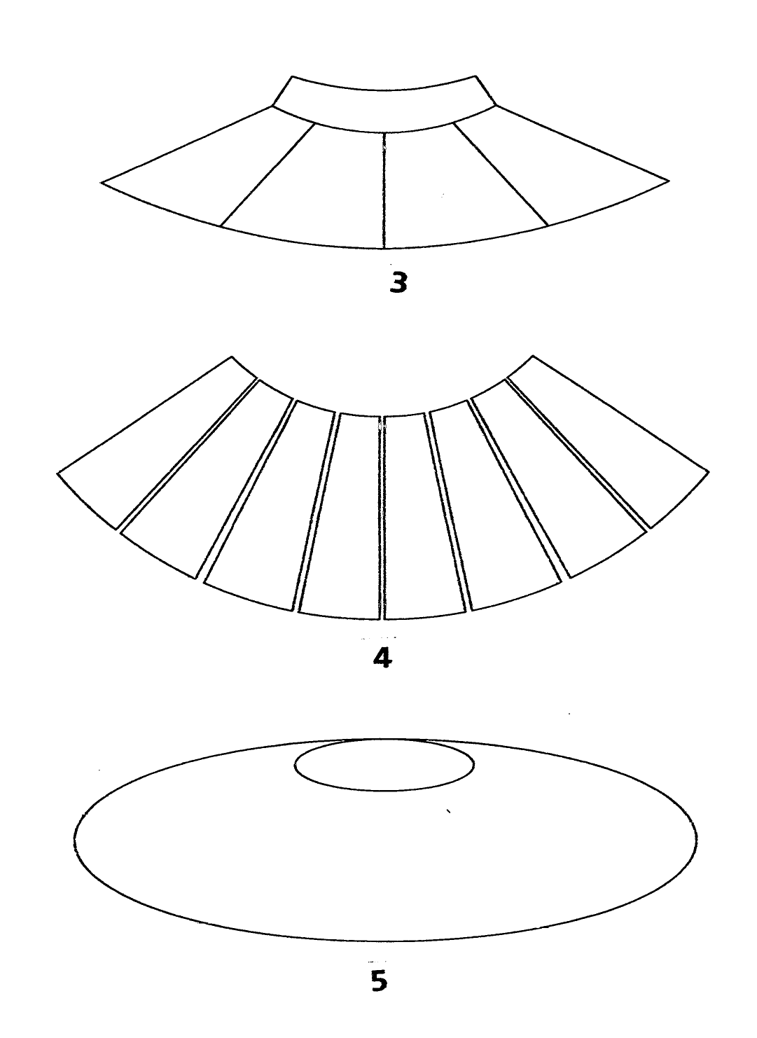

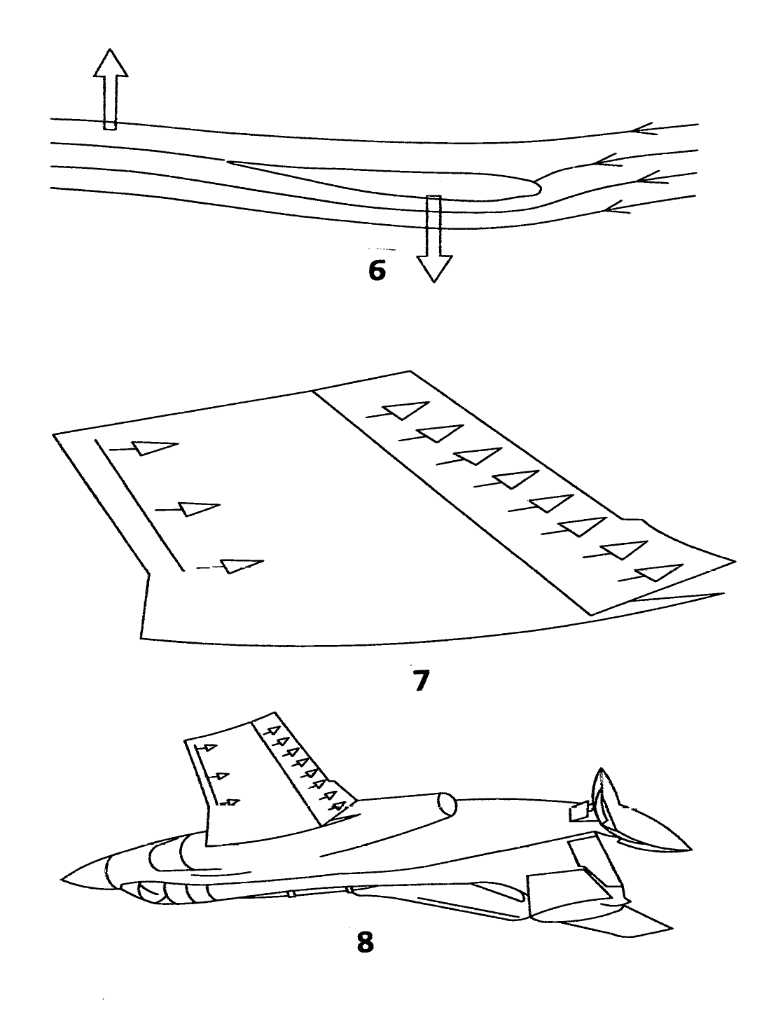

The patent idea and principal is based on the use of all the airfoil wing principals of aerodynamics on normal segment with wider rear edge than the front edge of Delta airplane wing foil with long root chord and finite short span with wider rear edge of the delta wing foil, with good lift NACA characteristics by Adding (integrating) the equal surfaces together to form complete circular disc (flying Saucer) and make it structurally stronger built, stiffer and at the same time lighter, its long root chord also allows a deeper structure for a given delta aerofoil section, providing more internal volume for fuel and other storage and Because of its light, robust structure with miniature span at an elevated angle from the ground level at the leading edge and on the ground level at the trailing edge end at an angle range between (0-45) degree and then join these equal segments next to each other to form complete disc FIG. 2, FIG. 3 but with hole in the middle where the cockpit, (the pilot cockpit can be placed at the top or at the lower part or the bottom of the flying disc to have better view on landing with the fuel tanks, luggage, equipment, and all heavy equipments, to lower the center of gravity of the flying disc for better flying disc stability in flight) and where the start of airflow entrance into the airfoil leading edge and at the tail of this disc where the airflow will exit the circular disc airfoil (Flying Saucer—coincidental resemblance) FIG. 3, and using the fact that airflow tends to stick to gently curved surfaces, a phenomenon called the Coandă effect and it is totally symmetrical, so in theory it should be unidirectional as directed by the thrust direction, (or duct fans with swivel gears) specially if several vectoring thrust engine are used in sufficient numbers (minimum of 3-4) engine fitted on the disc perimeters to be able to direct the disc—360 degree in any direction, and Vector up and down and these vectoring engine can be directed to lift and fly the disc and using all ring thrust to push the disc in any direction or in one direction

It should be noted that the overall flying disc shape saucer will have the shape of thick or thin aerodynamic foil depending on the use of the disc mission (subsonic or supersonic) and in all cases the disc will have lifting aerodynamic foil similar to NACA thick or thin foil characteristics and the transmission, of mechanical forces between a solid body and a fluid occurs at every point on the surface of the body

The wing surface of the disc shape will have thick airfoil wing like NACA 4412 (as an example) with good properties Or any good airfoil wings lifting abilities to give maximum lift, It is well known that the more curvature of the foil the more lift the wing will carry, also the greater the wing area the more the wing will lift and if the area of the wing is doubled the lift will also double, Which make the flying disc have an advantage over the usual airplanes All the outside surfaces can be covered with solar panels to help in supplying the Electricity and power needed to the flying Machine

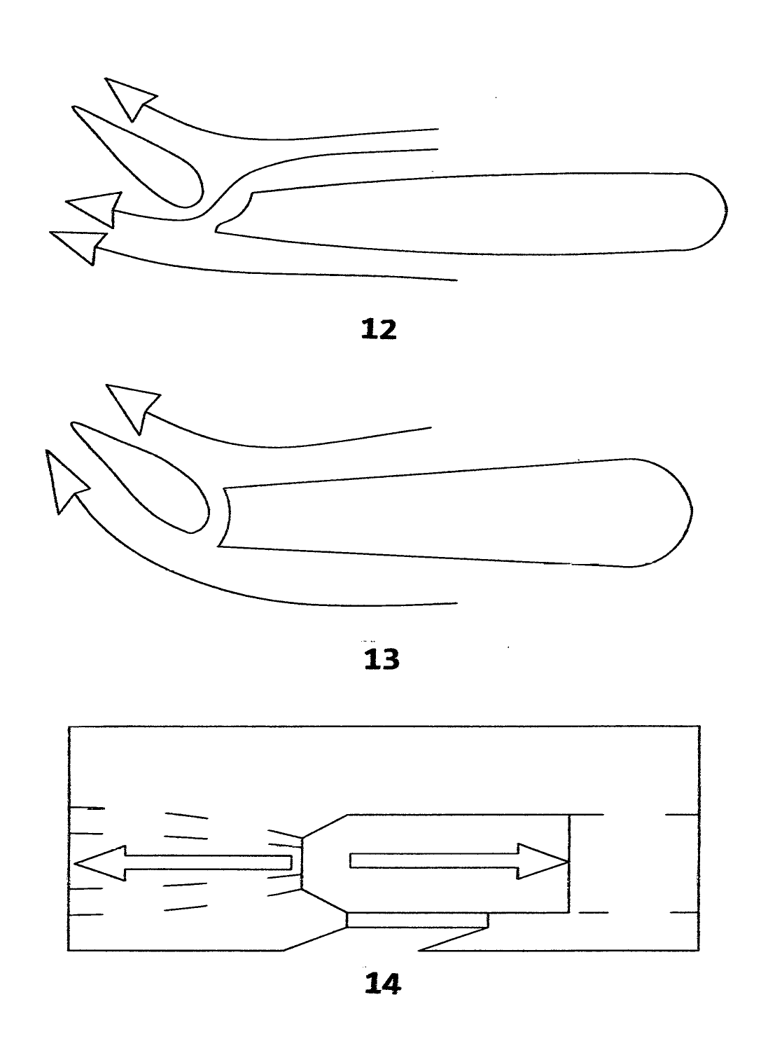

All flying airplanes and helicopters depend on one theory (aerodynamic forces) which explain how wings airfoil use the incoming air to produce lift and drag on the body of flying object FIG. 10

The theory use Bernoulli principle FIG. 7 which use the fact that when air passes awing (curved shape at the top surface upward—the more the better lift) the faster the air on say the upper part of the wing the less the pressure on the upper part of the wing which means an up lift produced on the wing, on the other hand if the lower part of this wing has curved also upward or straight with no curve then the air speed on the lower part of the wing will be slower than the upper part of the wing this can be explained with the logic that at the edge start of the wing air passing the start of the wing edge will split in two directions upper part and lower part the upper will have to travel longer distant than the lower part of the wing which can only happens if the air at the upper part of the wing will travel at much faster speed than the lower part of the wing to meet together at the same time at the end of the wing which what must happen in real wing air connection and this apply to the patent principals with the disc shape flying machine with middle central air inlet hole FIG. 3 where the cockpit also is placed and the curved upward disc delta shaped equal segments joint together and if these segments are finite then near smooth surfaces can be obtained on both upper and lower surfaces of the discs with all the aerodynamic forces apply in flying the disc shape flying machine, which can be confirmed by using Bernoulli formulas. All heavier than air flying machines must use the above theory to fly or use direct jet propulsions to push rockets against gravity or helicopter using rotating wings (propellers)

All flying machines use wings which can have thick shape curvature for slower heavy loads carrying flying machines (transport aircraft) but has high drag on the body of the flying machines, on the other side fast flying machines (fighter aircraft) use thin slender wings with much faster speed and less drag but carry less weight

The design of wings (airfoil) starts with the required characteristics for the lift coefficients, Reynolds or Mach numbers, stall characteristics, moments, thickness, drag, lift etc. The design can be done using numerical methods (using computers) or using design codes and improve on the design using wind tunnel in trial and error to fund best airfoil shape and all of the above designs points will apply and used in designing the new patent flying discs once the parameters are known to the designers with loads and speeds and takeoff distances and all other parameters and all the geometry and the shape of the body can be made using the patent geometry parameters from any suitable materials like fiberglass, polystyrene covered with aluminum foils or aluminum or very thin titanium or carbon fiber or any other suitable materials, using molds and jigs for the molds manufacture and jigs for assembly of the body of the flying discs using the above methods and apparatuses and in the designs will have several designs aids to increase lift

Engines and Thrust:

When a system expels or accelerates mass in one direction, the accelerated mass will cause a force of equal magnitude but opposite direction on that system. The force applied on a surface in a direction perpendicular or normal to the surface is called thrust FIG. 12, a fixed-wing aircraft generates forward thrust when air is pushed in the direction opposite to flight. Propeller, or a rotating fan pushing air out from the back of a jet engine, or by ejecting hot gases from a rocket engine The forward thrust is proportional to the mass of the airstream multiplied by the difference in velocity of the airstream

Reverse thrust can be generated to aid braking after landing by reversing the pitch of variable-pitch propeller blades, or using a thrust reverser on a jet engine. Rotary wing aircraft and thrust vectoring aircraft use engine thrust to support the weight of the aircraft, and vector sum of this thrust fore and aft to control forward speed

Rotating Duct Fans which can be fixed to the flying disc rear edges at the perimeter similar to jet engines and can be directed downward to the ground (minimum of 3 or 4 engines) at equal distance at the flying disc perimeter to give equal thrust for balance at takeoff and can be rotated to give horizontal thrust forward or up and down or any direction using computer instruments

The Flying Disc Thrust Vectoring;

propeller or jet propulsion (with thrust vectoring) put on the airfoil pushing air in any direction using thrust vectoring vanes apparatuses at the circular wing perimeter using thrust vectoring which curve the air at required direction so the airflow will hit the start front edge and flow over the wing curvatures of the circular wing the Coandă effect and hitting the trailer edge with its vanes flaps giving lift upward or any direction wanted using the thrust vectoring apparatuses due to the air being pushed on the circular wing and this can be done either using jet thrust vectoring or the propulsion or propellers with vanes flaps apparatuses.

At the perimeter of the circular disc on the rear edge of the circular wing, at least three or four or more fitted on the top or lower wing surfaces depending on its final use, equally spaced at the perimeter, thrust vectoring engines will be fitted all around the circular disc

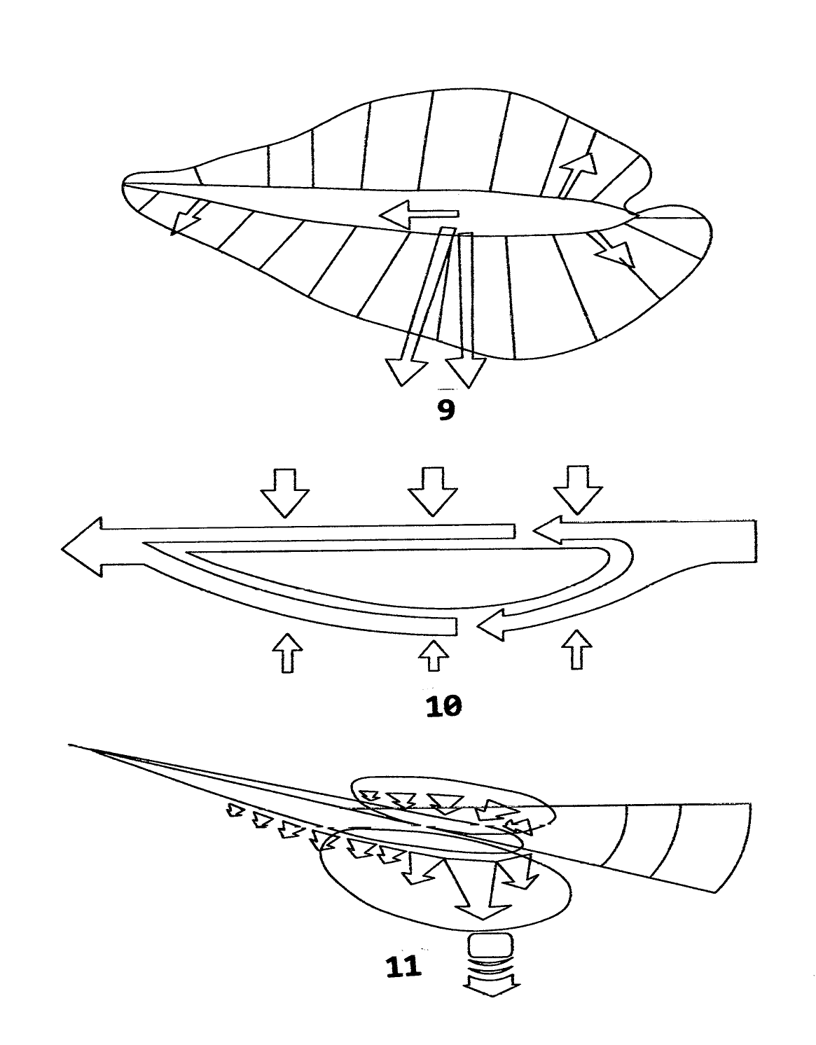

In the present invention, the aircraft includes an inner upward fuselage structure to hold the surface wing with the inner cockpit body wing surface with an airfoil designed winglet to hold both inner and outer wing surface together in flight FIG. 7 & FIG. 8

Diverges with flexible elbow {(0-90) degree, straight or down} are used to divert the air pushing on the circular wing surrounding the propeller or the jet propulsion at suitable angle of attack on the circular wing or pushing the airflow away from the tail edge of the wing flaps straight or done hitting the ground if fitted on the rear tail edge to give maximum lift

Alternatively propellers or thrust vectoring or circular air duct fan can be used to push airflow directly on the circular wing leading edge

All types of flying discs, mentioned in this patent, civilian or military large or small bi-flying disc or mono flying discs can have any type of flaps or slats that will help the designer of the flying discs;

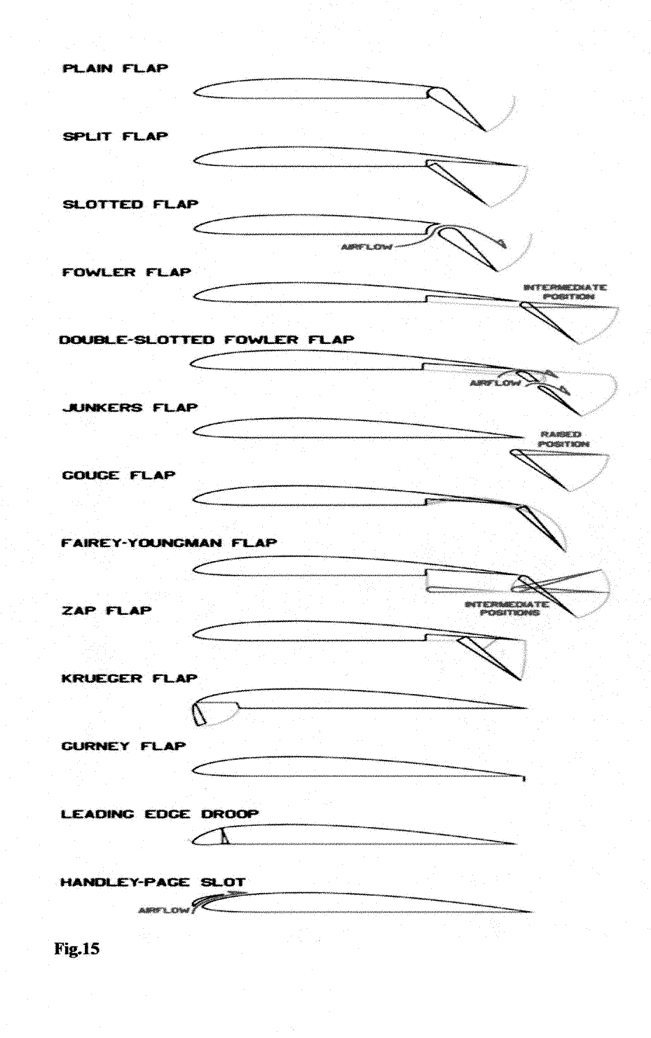

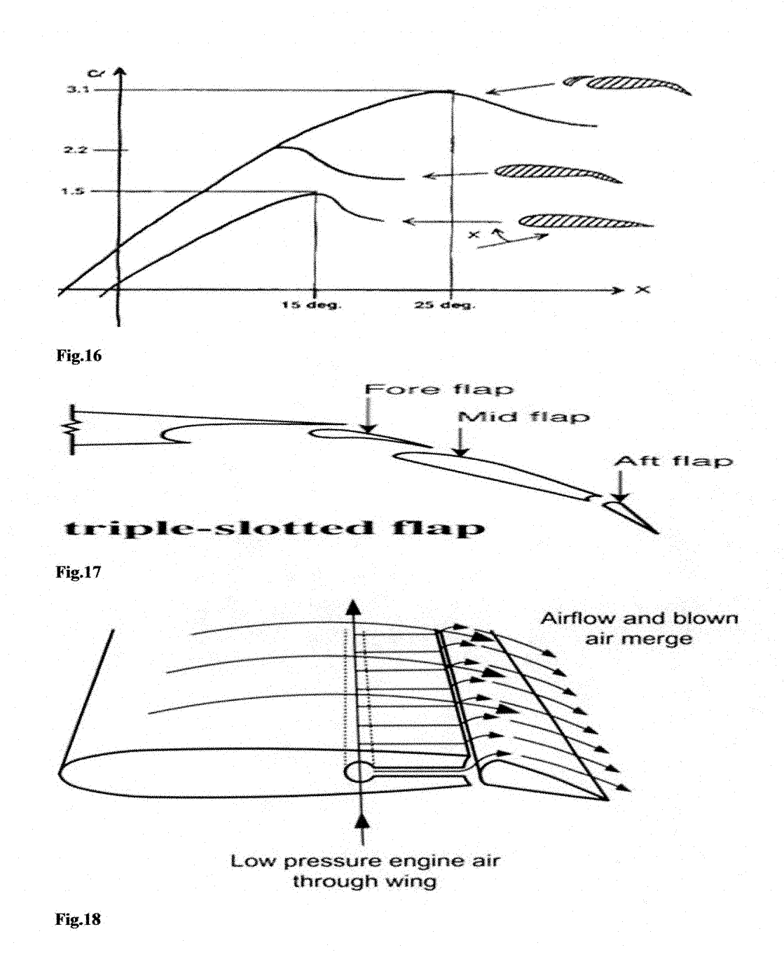

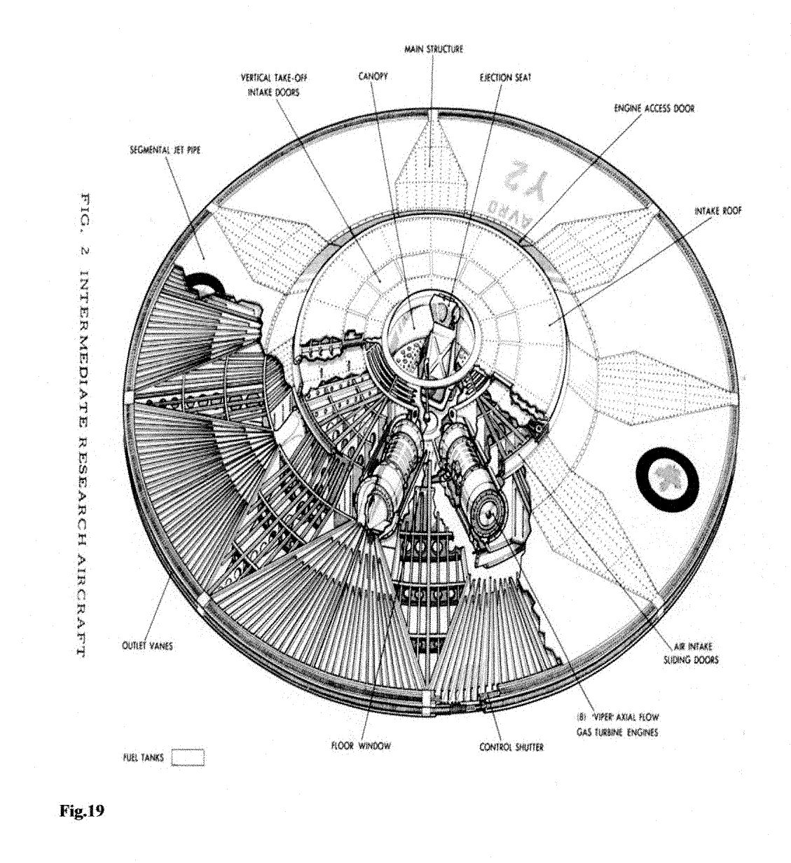

Flaps and Other High Lift Devices which can be Fitted to the Flying Machine Above as Follows FIG. 15;

1) Blown flaps, or jet flaps, the flying disc can use these flaps all around the upper surface of the flying discs beneficially these blown flaps to power aerodynamic high-lift devices used on the wings of to improve their low-speed flight characteristics. They use air blown through nozzles to shape the airflow over the rear edge of the wing, directing the flow downward to increase the lift coefficient, Using jet exhaust or high-pressure air bled off of a jet engine's compressor and then redirected to follow the line of trailing-edge flaps

2) The Junkers design is a slotted plain flap, where the flap is fixed below the trailing edge of the wing the flying disc can use these flaps all around the upper surface of the flying discs beneficially. This design allows airflow to pass between the wing and flap, even when the flap is retracted. Because of the increase in airflow, a significant increase in lift is added to the wings, even at slow speeds

3) Leading edge slats and slots are mounted on the top of the wings' leading edge and while they may be either fixed or retractable, the flying disc can use these flaps at the leading edge all around the upper surface of the flying discs beneficially when deployed they provide a slot or gap under the slat to force air against the top of the wing, they offer excellent lift and enhance controllability at low speeds, flaps may be equipped with one or more slots to increase their effectiveness

5) Spoilers are intended to create drag and reduce lift by “spoiling” the airflow over the wing. A spoiler can be retracted. Spoilers are usually installed mid chord on the upper surface of the Wing, but may also be installed on the lower surface of the wing as well

6) Ailerons several may be fitted to flying disc equally spaced and are similar to flaps (and work the same way), but are intended to provide lateral control—when an aileron on one wing increases the lift, the opposite aileron does not, and will often work to decrease lift FIG.

[symbol]

7) Plain flap at full deflection the flying disc can use these flaps all around the upper surface of the flying discs beneficially

8) Double slotted Fowler flaps extended for landing the flying disc can use these flaps all around the upper surface of the flying discs beneficially

9) Krueger flaps and triple-slotted trailing-edge flaps extended for landing the flying disc can use these flaps all around the upper surface of the flying discs beneficially

10) Winglets, an upturned extension of airplane wings that reduces drag and improves fuel efficiency, the flying disc can use these flaps all around the upper surface of the flying discs beneficially

11) Split flap, The rear portion of the lower surface of the airfoil hinges downwards from the leading edge of the flap, while the upper surface stays immobile, the flying disc can use these flaps all around the upper surface of the flying discs beneficially This can cause large changes in longitudinal trim, pitching the nose either down or up. At full deflection, a split flaps acts much like a spoiler, adding significantly to drag coefficient. It also adds a little to lift coefficient.

12) Slotted flap, A gap between the flap and the wing forces high pressure air from below the wing over the flap helping the airflow remain attached to the flap, increasing lift compared to a split flap, the flying disc can use these flaps all around the upper surface of the flying discs beneficially

13) Fowler flap A split flap that slides backwards, before hinging downward, thereby increasing first chord, then camber, the flap may form part of the upper surface of the wing, like a plain flap, or it may not, like a split flap, but it must slide rearward before lowering the flying disc can use these flaps all around the upper surface of the flying discs beneficially

Tests Carried Out by the Inventor on the Patent Principal;

Several successful flying Disc Tests on the flying patent principal were tested

Using several wing shapes using codes were tried to get best lift at best angle of air attack just before stall occurs

To get best lift characteristics balance were designed where the model where placed with small driving engine placed underneath the model and counterbalance was placed on the other arm at same distance from the center

When the engine starts weights is placed underneath the engine to keep the model at the same height level by putting weights to balance the lift after which the coefficient of lift is calculated using Bernoulli's formula assuming air has fixed density W=(LC)*(AIRd)*A*(v*2)

Good results were obtained using delta triangular segments to form circular wing FIG. 2 as described above but have sharp thick upper part of the wing copied from the wing code to gave maximum lift at wind angle of attack (12 deg) but the lower wing surface had straight surface at wind angle of attack approximately (12-45 deg) which gave good uplift results.

Confirmation tests were done to see if Airflow tends to stick to gently curved surfaces, a phenomenon called the Coandă effect,

At the leading edge of the circular wing and at the trailing edge flat or curved pieces are attached to these edges with full control on them by the autopilot for stability and the pilot which will help to control the aircraft in any direction needed to go.

To give the aircraft much faster movement horizontally in 360 deg one or more propeller or jet can be fitted underneath the pilot cockpit or attached to the circular wing which will give the aircraft several degree of movement (360 deg and vertical movement).

Several possibilities can be added to the circular wings like slots curved starter edges and this circular wing will take all the fittings and the winglets that straight normal wings uses and will apply to this circular new wing

To stop gyro inertia rotation in the tests when using propeller two propellers turning in opposite direction (like some helicopters use) or several rotating gyroscopes were attached to the circular wing lower rim calculated to stop the inertia rotation

This aircraft can take off at any place and no need for airport at takeoff or landing and will take the roll of helicopter in vertical takeoff and fly horizontally like any other civilian aircraft and will have minimum drag due to its slender and rugged shape (dome shell) even when flying at high speed with fast movement in all direction

These prototypes aircrafts had 2-6 meter diameter and can be very large and carry several thousand passengers with very rigid shape and structure (shell shaped dome one of the strongest shapes in nature)

Landing on sea water is possible with necessary design adjustments, the Flying Machine can be designed to have all parts waterleaf proof with all adjustment to be a submarine with all hydrodynamic parts fitted and designed to submerge in water with the same shape of the flying disc

1) The Flying Machine can replace the helicopters as it can fly vertically and can carry as many passengers or cargo as needed depending on the size of the shell body and the power and numbers of engines,

2) The Flying Machine can be designed to float on water if required

3) Simple to build and can be built in very large sizes, depending on the power and numbers of engines fitted to the body shell of the Flying Machines

4) This Flying Machine will never be hit by any Rocket or missile as it can move very fast in any direction (At 90 deg to the direction of the missile coming, UP, DOWN, SIDE WAYS, FRONT & BACK) and Can keep safe distance away from any self destructive coming rockets using computers and their sensors

5) The shell body of the flying machine (will not be lifted by single shaft, the connection between the helicopter body and the top lifting fan blades—the weak point in helicopter designs)

6) The Flying Machine can be designed to push the jet or propeller air in the direction of the airfoil cord which will give vertical uplift (negative pressures and vacuum on the upper surfaces of the circular curved wings)
(Chord refers to the imaginary straight line joining the leading and trailing edges of an aerofoil)

7) Due to the vertical lift produced by the surface of the circular curved wing airfoil (like normal curved airplane foils) and the thrust engines uplift in takeoff and landing of the new circular curved wing (Flying Machine), it can stay flying in the air with stationary position using the engines and the computer controls gyroscopes.

8) The Flying Machine can be designed to fly horizontally in any direction very fast (supersonic), slim shape with minimum drag resistance or designed slower carrying heavier loads (subsonic) depending on the thickness of the flying circular wing disc designs.

9) The Flying Machine is suitable to be an invisible aircraft (Stealth) to radars if designed as follows;
A) Made with flat panels, called facet surfaces which would radiate almost all of the radar energy away from the receiver if designed like diamond shaped
B) Using carbon-impregnated plywood resins which will absorb radar waves,
Stealth aircraft often have skins made with Radar-absorbent materials
C) Disguise its infrared emissions to make it harder to detect
D) Designers also addressed making the aircraft less visible to the naked eye, controlling radio transmissions, and noise abatement

10)The Flying Machine Can be used like submarines after doing the necessary alterations, all made waterproof and using all the hydrodynamic principals to build the new shape submarine if all parts are made water leak proof and use hydrodynamic principals in its designs but using the same shape and suitable hydrodynamic thrust propeller Engines.

11) The Flying Machines can take off and land in any airport or land or any site Available (like helicopters)

12) The Flying Machines can take off and land on sea or any water pond after making adjustments and fittings for the flying machines to float, (like the navy sea floating helicopters)

13) The Flying Machines can take off and land horizontally in any airport like normal airplanes
